(19) United States
(12) Patent Application Publication
(10) Pub. No.: US 2026/0119128 A1
(43) Pub. Date: Apr. 30, 2026

(54) SYSTEMS AND METHODS FOR AUTOMATICALLY AND DYNAMICALLY GENERATING SOFTWARE PROGRAMS FROM DISPARATE SOURCES

(71) Applicant: BANK OF AMERICA CORPORATION, Charlotte, NC (US)

(72) Inventors: Malinda Mae Kieffer, Chillicothe, MO (US); Kirk A. Hawrysio, Oak Point, TX (US); Pankaj Nagpal, Charlotte, NC (US); Noel Arnaldo Medina, Katy, TX (US); Owen Nelson, Farmingdale, NY (US); Naveen Adala, Charlotte, NC (US); Anne M. Matrone, Staten Island, NY (US); Kevin A. Delson, Woodland Hills, CA (US); John David Weber, Lake St. Louis, MO (US); Tanya A. Wilson, Newark, DE (US); Robert R. Rosseland, Huntersville, NC (US); Thomas David Morris, Middleburg, FL (US)

(73) Assignee: BANK OF AMERICA CORPORATION, Charlotte, NC (US)

(21) Appl. No.: 18/925,968

(22) Filed: Oct. 24, 2024

(51) Int. Cl. G06F 8/33; G06F 9/451; G06F 21/60

(52) U.S. Cl. CPC G06F 8/33; G06F 9/451; G06F 21/604

(57) ABSTRACT

Systems, computer program products, and methods are described herein for automatically and dynamically generating software programs from disparate sources. The present disclosure is configured to generate an interactive generative artificial intelligence (AI) engine, wherein the interactive generative AI engine is configured on a graphical user interface (GUI) of a user device; receive, by the interactive generative AI engine, a software tool request; generate, by the interactive generative AI engine and based on the software tool request, a data source prompt; receive, by the interactive generative AI engine, a data source identifier in response to the data source prompt; access, by the interactive generative AI engine, a data source associated with the data source identifier; and automatically generate, by the interactive generative AI engine, a software tool based on the software tool request and the data source.

### TECHNOLOGICAL FIELD

Example embodiments of the present disclosure relate to automatically and dynamically generating software programs from disparate sources.

### BACKGROUND

In today's electronic environment, software programs and tools are time consuming and difficult to generate, especially when data from multiple, disparate data sources (e.g., databases, programs, applications, files, and/or the like) are used to generate the software tools. With these disparate data sources, the data within the disparate data sources are difficult to query and parse to determine if the intended data is present in an efficient and streamlined manner, without unduly wasting network resources with unnecessary queries and commands to these data sources. Thus, a system, computer program product, and computer implemented method are needed to efficiently, dynamically, accurately, and automatically generate software tools and programs from disparate data sources.

Applicant has identified a number of deficiencies and problems associated with automatically generating software programs/tools from disparate data sources. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatically and dynamically generating software programs from disparate sources.

In one aspect, a system for automatically and dynamically generating software programs from disparate sources. In some embodiments, the system may comprise: a memory device with computer-readable program code stored thereon; at least one processing device operatively coupled to the at least one memory device and the at least one communication device, wherein executing the computer-readable code is configured to cause the at least one processing device to: generate an interactive generative artificial intelligence (AI) engine, wherein the interactive generative AI engine is configured on a graphical user interface (GUI) of a user device; receive, by the interactive generative AI engine, at least one software tool request; generate, by the interactive generative AI engine and based on the at least one software tool request, a data source prompt; receive, by the interactive generative AI engine, at least one data source identifier in response to the data source prompt; access, by the interactive generative AI engine, at least one data source associated with the at least one data source identifier; and automatically generate, by the interactive generative AI engine, a software tool based on the software tool request and the at least one data source.

In some embodiments, the at least one data source is a plurality of disparate data sources.

In some embodiments, executing the computer-readable code is further configured to cause the at least one processing device to: identify a user account associated with the user device, wherein the user interacting with the user device causes a generation of the software tool request and the at least one data source identifier; determine a security clearance of the user account; compare the security clearance with a security requirement associated with the at least one data source identifier; and automatically allow the generation of the software tool in an instance where the security clearance meets or exceeds the security requirement. In some embodiments, executing the computer-readable code is further configured to cause the at least one processing device to: automatically block the generation of the software tool in an instance where the security clearance does not meet or exceed the security requirement.

In some embodiments, executing the computer-readable code is further configured to cause the at least one processing device to: receive, by the interactive generative AI engine, at least one recipient identifier to receive the software tool; identify, based on the at least one recipient identifier, at least one recipient security clearance for each of the at least one recipient identifier; compare the at least one recipient security clearance with a security requirement associated with the at least one data source identifier; and automatically allow the transmission of the software tool to at least one recipient account associated with each of the at least one recipient identifier that comprises the at least one recipient security clearance that meets or exceeds the security requirement. In some embodiments, executing the computer-readable code is further configured to cause the at least one processing device to: generate, by the interactive generative AI engine and in an instance where the at least one recipient security clearance does not exceed the security requirement, an updated recipient identifier prompt; and transmit the updated recipient identifier prompt to the user device.

In some embodiments, at least one of the data source prompt, a recipient identifier prompt, or an updated recipient identifier prompt is generated as a computer-generated speaker output.

In some embodiments, at least one of the at least one software tool request, the at least one data source identifier, or a recipient identifier is received by the user device as a sound input, and wherein the interactive generative AI engine parses and extracts the at least one software tool request, the at least one data source identifier, or the recipient identifier from the sound input.

In some embodiments, executing the computer-readable code is further configured to cause the at least one processing device to: generate an interactive software tool database, wherein the interactive software tool database is configured on the GUI of the user device, and wherein the interactive software tool database comprises each software tool generated for a user account with real-time data of each software tool comprising an active software tool task indicator or an inactive software tool task indicator.

In some embodiments, executing the computer-readable code is further configured to cause the at least one processing device to: access, by the interactive generative AI engine, a software tool database comprising each previous software tool generated by the interactive generative AI engine; generate, by the interactive generative AI engine and based on the software tool database, the software tool, wherein the software tool is based on at least one previous software tool from the software tool database.

In some embodiments, executing the computer-readable code is further configured to cause the at least one processing device to: train the interactive generative AI engine with a specific user account dataset or a general user account database comprising a plurality of user account datasets.

In some embodiments, executing the computer-readable code is further configured to cause the at least one processing device to: receive feedback from the user device in response to generating the software tool; and train the interactive generative AI engine using the feedback from the user device.

In some embodiments, executing the computer-readable code is further configured to cause the at least one processing device to: receive, by the interactive generative AI engine, at least one recipient identifier to receive the software tool; determine, based on the at least one recipient identifier, at least one recipient preference for each of the at least one recipient identifier; and automatically configure the software tool based on the at least one recipient preference.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically and dynamically generating software programs from disparate sources, in accordance with an embodiment of the disclosure;

FIG. 2 illustrates an exemplary generative AI subsystem, in accordance with an embodiment of the disclosure;

FIG. 3 illustrates a process flow for automatically and dynamically generating software programs from disparate sources, in accordance with an embodiment of the disclosure;

FIG. 4 illustrates a process flow for determining a security clearance of a user account for the generation of the software tool, in accordance with an embodiment of the disclosure;

FIG. 5 illustrates a process flow for determining a recipient security clearance of a recipient user account for receiving the software tool, in accordance with an embodiment of the disclosure;

FIG. 6 illustrates a process flow for generating the software tool using previously generated software tools, in accordance with an embodiment of the disclosure;

FIG. 7 illustrates a process flow for training the interactive generative AI engine in multiple instances, in accordance with an embodiment of the disclosure;

FIG. 8 illustrates a process flow for automatically configuring the software tool based on the recipient preference(s), in accordance with an embodiment of the disclosure;

FIG. 9 illustrates an exemplary interactive generative AI engine configured on a graphical user interface, in accordance with an embodiment of the disclosure; and

FIG. 10 illustrates an exemplary interactive software tool database, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's electronic environment, software programs and tools are time consuming and difficult to generate, especially when data from multiple, disparate data sources (e.g., databases, programs, applications, files, and/or the like) are used to generate the software tools. With these disparate data sources, the data within the disparate data sources are difficult to query and parse to determine if the intended data is present in an efficient and streamlined manner, without unduly wasting network resources with unnecessary queries and commands to these data sources. Thus, a system, computer program product, and computer implemented method are needed to efficiently, dynamically, accurately, and automatically generate software tools and programs from disparate data sources.

Accordingly, the present disclosure provides for the generation of an interactive generative artificial intelligence (AI) engine, wherein the interactive generative AI engine is configured on a graphical user interface (GUI) of a user device; the receipt, by the interactive generative AI engine, of at least one software tool request; the generation, by the interactive generative AI engine and based on the at least one software tool request, of a data source prompt; and the receipt, by the interactive generative AI engine, of at least one data source identifier in response to the data source prompt. Additionally, the present disclosure further provides for the accessing, by the interactive generative AI engine, of at least one data source associated with the at least one data source identifier; and the automatic generation, by the interactive generative AI engine, of a software tool based on the software tool request and the at least one data source.

In other words, the disclosure provides a system for automatically generating software programs or applications based on a user interacting with a generative AI engine that generates questions to the user associated with building out the program and receives/parses the inputs from the user. In some embodiments, the user may input recipient identifiers (e.g., email addresses, user IDs, and/or the like) for the software programs, and the system may, itself, automatically determine what security protocols the recipient user is able to access and whether the generated program fits the parameters of the security protocols for the recipient user. Further, the system may be able to access files, sites, and/or the like, that match the security level of the user interacting with the generative AI engine and move data between different software programs and/or websites to generate the files, applications, programs, and/or the like, whereby the system may assemble the generated software program by extracting portions of code from various software libraries. Additionally, and in some embodiments, the system may automatically generate a dashboard for the user to access each piece of software they have generated, historically and in real time.

What is more, the present disclosure provides a technical solution to a technical problem. As described herein, the technical problem includes automatically generating software programs/tools from disparate data sources. The technical solution presented herein allows for the efficient, dynamic, accurate, and automatic generation software tools and programs from disparate data sources. In particular, the disclosure is an improvement over existing solutions to the automatic generation of software tools, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

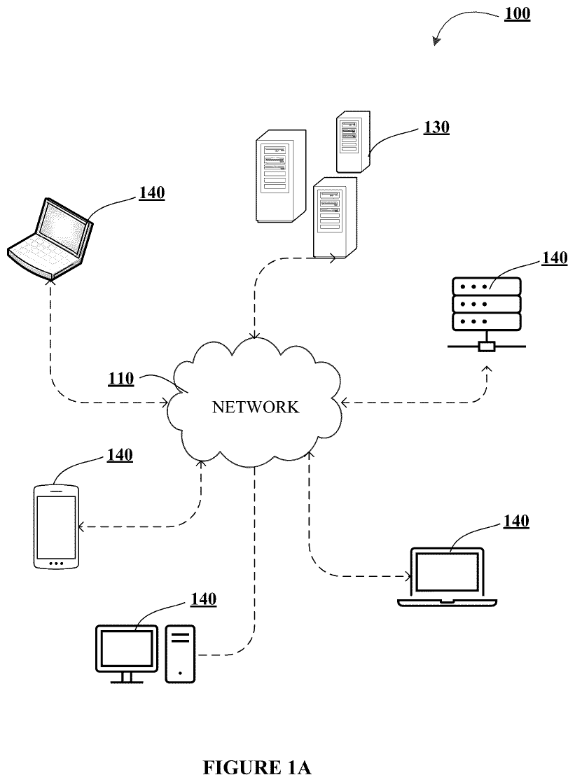

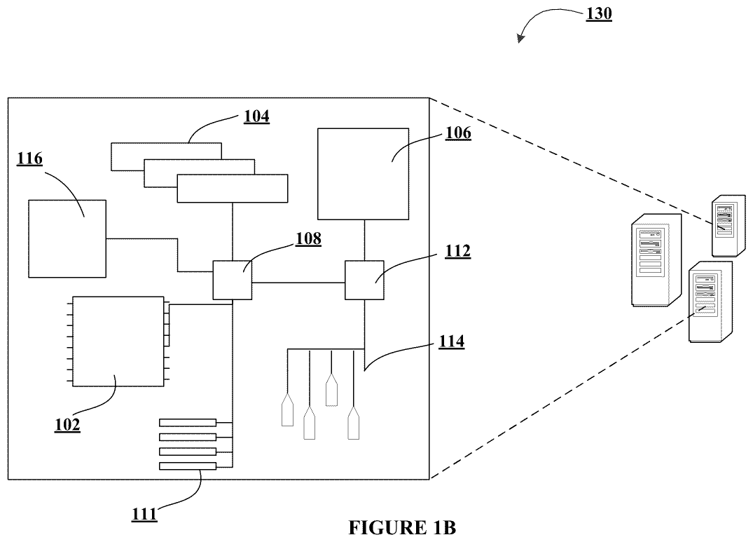

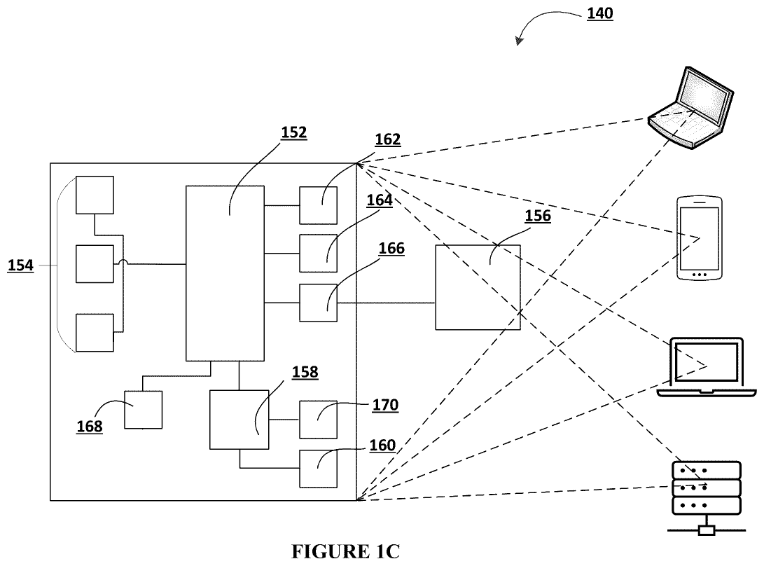

FIGS. 1A-1C illustrate technical components of an exemplary distributed computing environment for automatically and dynamically generating software programs from disparate sources 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

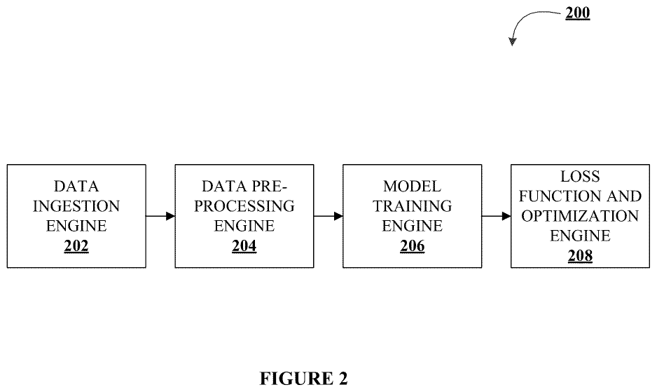

FIG. 2 illustrates an exemplary generative AI subsystem 200, in accordance with an embodiment of the disclosure. The generative AI subsystem 200 may include a data ingestion engine 202, a data pre-processing engine 204, a model training engine 206, and a loss function and optimization engine 208. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 202 may move the data to a destination for storage or further analysis. Typically, the data may be in varying formats as they come from different sources, including RDBMS, other types of databases, S3 buckets, CSVs, or from streams. For a large language model (“LLM”), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 204 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that are suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training module 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data is used to update the model's parameters, while the validation and testing datasets are reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206 may implement optimization techniques such as gradient clipping, learning rate scheduling, and mixed-precision training. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

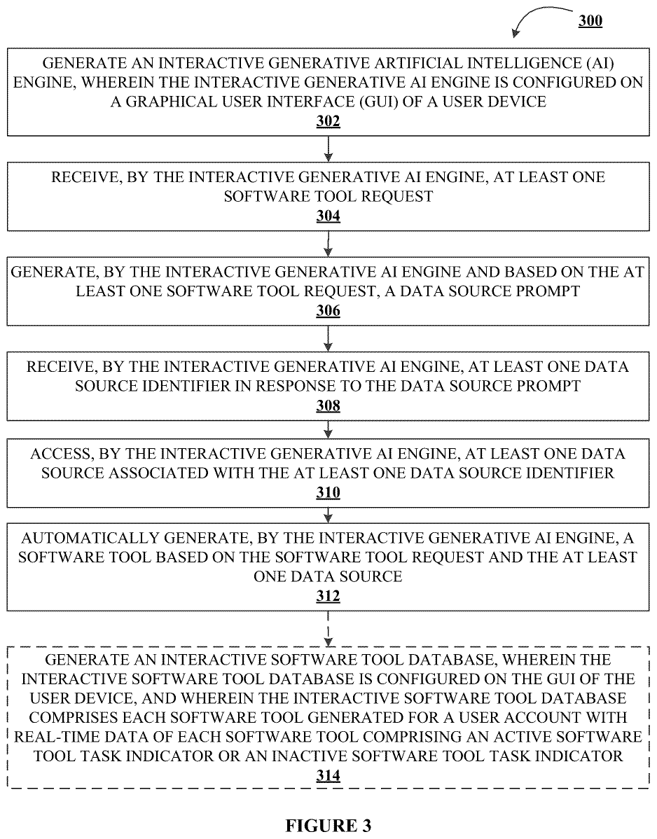

FIG. 3 illustrates a process flow 300 for automatically and dynamically generating software programs from disparate sources, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process flow 300. Additionally, and in some embodiments, a generative AI engine (e.g., the generative AI subsystem 200 described herein with respect to FIG. 2) may be generated to perform the steps of process flow 300.

As shown in block 302, the process flow 300 may include the step of generating an interactive generative artificial intelligence (AI) engine, wherein the interactive generative AI engine is configured on a graphical user interface (GUI) of a user device. For instance, the system may train and generate an interactive generative AI engine, which may receive user inputs at a user device the interactive generative AI engine is configured on. Thus, and as the user inputs are received in real time, the interactive generative artificial intelligence (AI) engine may parse the user inputs, extract the important data from the user input (e.g., the information associated with a command or response to a prompt that was generated by the interactive generative artificial intelligence (AI) engine), and analyze the important data to generate a follow-up prompt, access a data source, and/or generate a software tool. Thus, and as used herein the interactive generative artificial intelligence (AI) engine may be similar to the generative AI subsystem described above with respect to FIG. 2.

Additionally, the system may transmit the interactive generative artificial intelligence (AI) engine to a user device, such as a user device that has requested access to the interactive generative artificial intelligence (AI) engine over a network connection (e.g., at a web browser, via a plugin, via an application, and/or the like), and/or the like. In some such embodiments, the interactive generative artificial intelligence (AI) engine may be transmitted to the requesting user device and may, upon the transmission to the user device, automatically configure the GUI of the user device to show the interactive generative artificial intelligence (AI) engine, the prompts generated by the interactive generative artificial intelligence (AI) engine, and to receive responses at the user device to each of the prompts.

Further, and in some embodiments, the interactive generative artificial intelligence (AI) engine may be trained on an individual user account, such that the interactive generative artificial intelligence (AI) engine is user specific. Additionally, and/or alternatively, the interactive generative artificial intelligence (AI) engine may be trained on a general user database comprising a plurality of user datasets for a plurality of user accounts (such as a plurality of user accounts within an entity or company using the system to generate software tools).

As shown in block 304, the process flow 300 may include the step of receiving, by the interactive generative AI engine, at least one software tool request. For instance, the system may receive—by the interactive generative AI engine—at least one software tool request from the user device. Such a software tool request may comprise a request generated by the user interacting with the interactive generative AI engine at the user device and submitting a request for the interactive generative AI engine to generate a software tool based on the user inputs. In some embodiments, such a software tool may comprise a report of data, an update or change to a software application, a small piece of software to update a process or application, monitor updates to applications or databases, monitor data center levels or performance, generate an electronic communication to recipients (e.g., an email, phone call, a text message, an SMS message, and/or the like), build a dashboard of tasks or projects currently active or inactive, and/or the like. As used herein, the interactive generative AI engine may generate a software tool that was previously only generated by manual intervention or manual generation, which may have previously included searching, accessing, and collecting data from different data sources or data repositories (which, may be an extremely time-consuming process) and combining different pieces of data or different pieces of applications to generate the software tool.

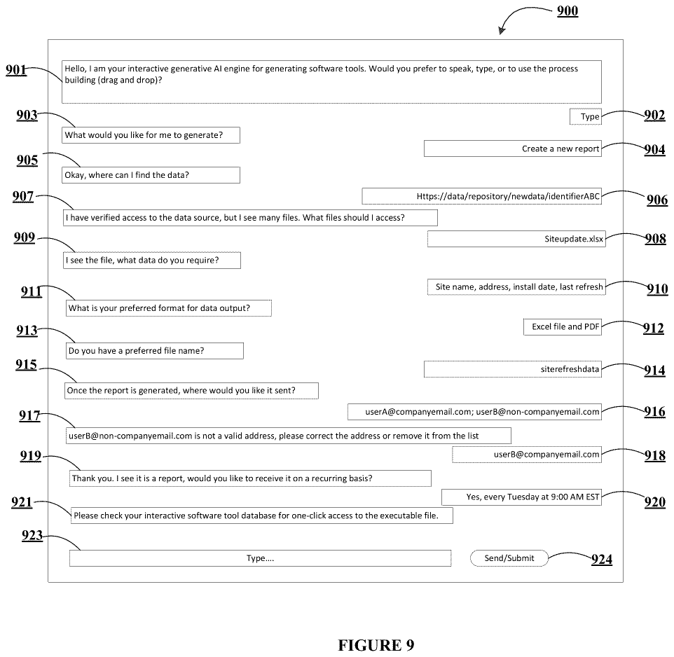

In some embodiments, the interactive generative AI engine may receive inputs via a user of the user device submitting user inputs at the user device (e.g., by typing, mouse or trackpad clicking, selecting, speaking into a microphone of the user device, and/or the like). In some embodiments, the interactive generative AI engine may be configured on the user device's GUI as a chat interface component between the interactive generative AI engine and the user of the user device, similar to the exemplary user interface of FIG. 9 (which is described in further detail below).

As shown in block 306, the process flow 300 may include the step of generating, by the interactive generative AI engine and based on the at least one software tool request, a data source prompt. For instance, the interactive generative AI engine may generate a data source prompt, which may request at least one data source identifier from the user that identifies which data source(s) the interactive generative AI engine should pull data from to generate the software tool. For instance, and where the software tool request comprises a request to generate an application from scratch, the interactive generative AI engine may request data sources to pull data from, or to pull pieces of an application from, such that the interactive generative AI engine can build the software tool according to the specifications of the user. In some embodiments, and where the user doesn't know which data sources that data or pieces of applications should be pulled from, then the interactive generative AI engine may analyze the software tool request (and other user inputs received from the user in the current session and prior sessions), determine historical data sources that have been used to build similar software tools, and may use the same or similar data sources to pull the data or pieces of applications from. In some embodiments, and where the interactive generative AI engine is not user specific, the interactive generative AI engine may analyze historical user inputs from the users within the same entity, their requested historical software tools, and their historical data source identifiers, to identify the appropriate data sources in the current session. Additionally, and upon generating the data source prompt, the system may configure the GUI of the user device to show the user of the user device the data source prompt (e.g., such as within the chat window generated and configured by the system).

In some embodiments, at least one of the data source prompt, a recipient identifier prompt, or an updated recipient identifier prompt is generated as a computer-generated speaker output. Thus, and using the speaker of the user device, the interactive generative AI engine may generate each of the prompts described herein as a speaker output. Thus, and in some such embodiments, the prompts may be generated as computer-generated speech. In some similar embodiments, at least one of the at least one software tool request, the at least one data source identifier, and/or a recipient identifier is received by the user device as a sound input, and wherein the interactive generative AI engine parses and extracts the at least one software tool request, the at least one data source identifier, and/or the recipient identifier from the sound input. Thus, and in some such embodiments, the responses to the prompts may be received by the system as a microphone input at the user device, which may be generated by the user of the user device and spoken into the user device's microphone or an external microphone of the user device.

As shown in block 308, the process flow 300 may include the step of receiving, by the interactive generative AI engine, at least one data source identifier in response to the data source prompt. For example, the interactive generative AI engine may receive at least one data source identifier for the interactive generative AI engine to pull the data (and/or application pieces, software code pieces, and/or the like) from, which may then be used to generate the requested software tool. As used herein, the data source identifier may comprise a unique string of characters (e.g., an http address, a unique location for a database and/or a unique location within a database, a file location, a document name, and/or the like) which uniquely identifies the location of the data source. In some embodiments, and where a first data source identifier only identifies a database comprising a plurality of files, tables, and/or the like, the interactive generative AI engine may generate a follow up data source prompt which requests the user to identify a specific data source identifier within the initial data source identifier (e.g., a specific file, a specific table, a specific cell of data, and/or the like). In some embodiments, the data source identifier (and/or any follow up data source identifiers) may be received by the interactive generative AI engine by identifying a user input at the user device while the user is interacting with the interactive generative AI engine-configured GUI.

As shown in block 310, the process flow 300 may include the step of accessing, by the interactive generative AI engine, at least one data source associated with the at least one data source identifier. For example, the interactive generative AI engine may access the at least one data source associated with each received data source identifier(s), by generating a query(ies) for the data source(s) (which may comprise a query with specific data source within the data source to collect), an import command(s) for data source(s), and/or the like. In some embodiments, the system may access a plurality of data sources in parallel and in real time to receiving the data source identifiers. In some other embodiments, the system may access a plurality of data sources in the sequence each data source identifier is received, in real time or near real time.

As used herein, the “data source” may be comprise database of disparate data from disparate sources (e.g., such as disparate applications, programs, databases, tables, and/or the like), a plurality of databases generated from disparate data sources (e.g., disparate applications, programs, databases, data centers, tables, emails, and/or the like), and/or the like. Such disparate sources may be organized in different and distinct formats (with different and distinct organization protocols, data types, and/or the like), or a in similar formats.

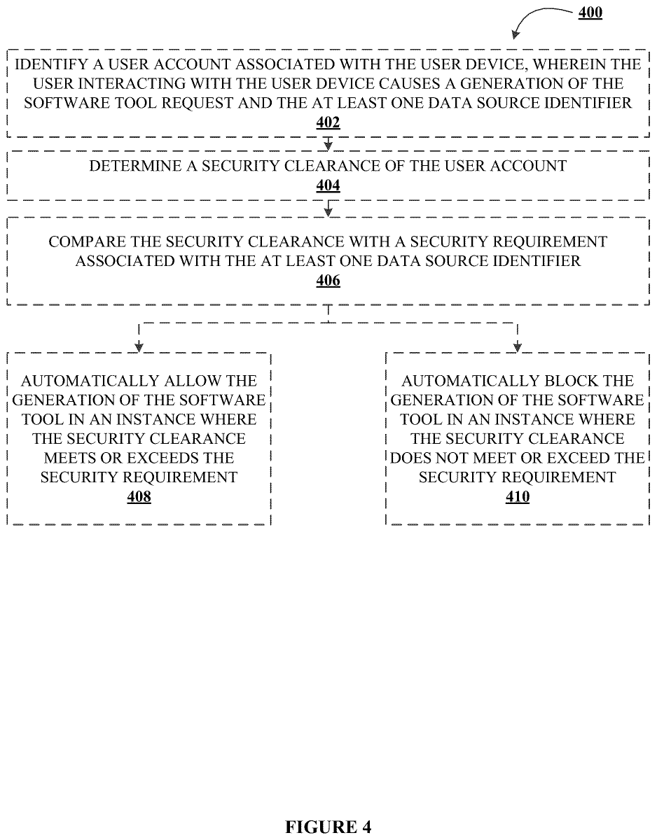

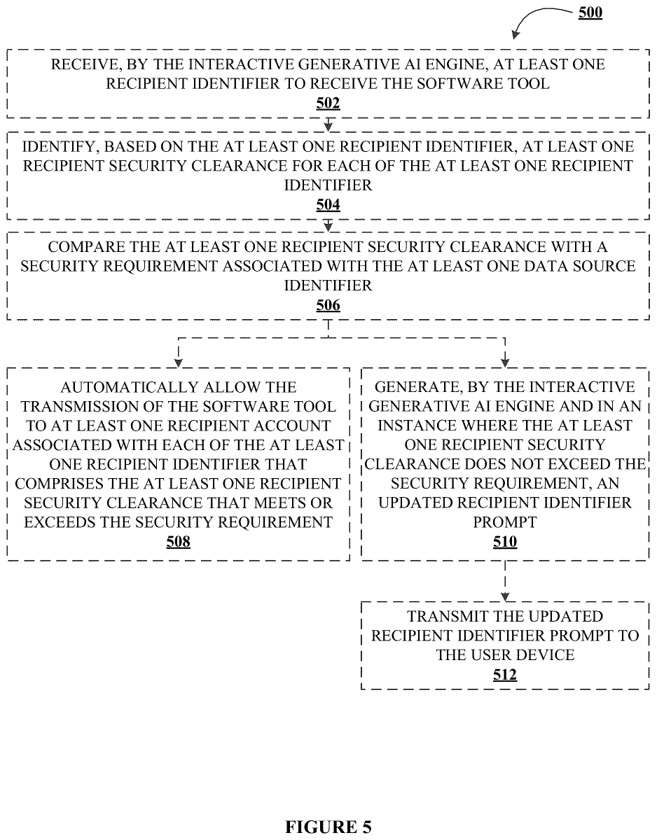

In some embodiments, and upon receiving the data source identifier, the system may perform a data security analysis to determine whether the user account associated with the user that generated the software tool request has security clearance to access the data of the data sources, and thus, has access to the software tool using the data source data when the software tool is generated. Thus, and in some instances where the user does not have the proper security clearance, the system may deny or block the process described herein for generating the software tool from continuing and reserve computing resources for other processes, rather than using unnecessary computing resources to generate a software tool that cannot be used by the user. Similarly, and in some embodiments, the system may perform a data security analysis on the recipient identifiers selected by the user to receive the software tool, and in an instance where a recipient is determined to not have the proper security clearance, then the system may conserve network resources by blocking the transmission of the software tool to improper recipient. Such an embodiment is described in further detail below with respect to FIGS. 4 and 5.

As shown in block 312, the process flow 300 may include the step of automatically generating, by the interactive generative AI engine, a software tool based on the software tool request and the at least one data source. For example, the system may automatically generate the software tool that was requested in block 302 based on combining the data accessed and collected in block 310 from the data source(s). In some embodiments, the interactive generative AI engine may automatically generate the software tool by combining data and/or pieces of applications or software code from a plurality of data sources, whereby the interactive generative AI engine is pre-trained to combine the data and/or application pieces to generate each software tool requested in an automatic, streamlined, dynamic, and efficient manner.

As used herein, the “software tool” may comprise an application, a program, a report, a database, an interface component for configuring a GUI, and/or the like. In other words, the software tool may comprise a piece of software, a file, a data storage component, a program, an electronic process, and/or the like that may have previously been manually generated in a computing environment, but may now be automatically generated by the interactive generative AI engine.

In some embodiments, and as shown in block 314, the process flow 300 may include the step of generating an interactive software tool database, wherein the interactive software tool database is configured on the GUI of the user device, and wherein the interactive software tool database comprises each software tool generated for a user account with real-time data of each software tool comprising an active software tool task indicator or an inactive software tool task indicator. For instance, and in some such embodiments, the system may generate an interactive software tool database which is configured to appear on the GUI of the user device and show data of each of the current and historical software tools generated for the user of the user device and/or of associated users within the same entity as the user. In this manner, the interactive software tool database may be interactive on the user device's GUI, such that user can select each software tool that was previously generated, access each software tool, and gather data from the software tool, update parameters of the software tool (e.g., update the intervals to receive an output from the software tool like a report, and/or the like), and/or the like.

In some embodiments, the interactive software tool database may comprise a full report of each software tool generated for a user account or used by the user account and their indicators of whether the software tools are still active or inactive and/or whether the software tools are still needed or not. For instance, the interactive software tool database may comprise an indicator (such as a color highlighting of a software tool component shown in the GUI, a pop-up notification, and/or the like) that indicates whether the software tool and its intended purpose are still active or inactive (e.g., the software tool is still necessary as the underlying purpose behind the generation of the software tool is still a problem that needs to be addressed or is an ongoing task that needs to be addressed).

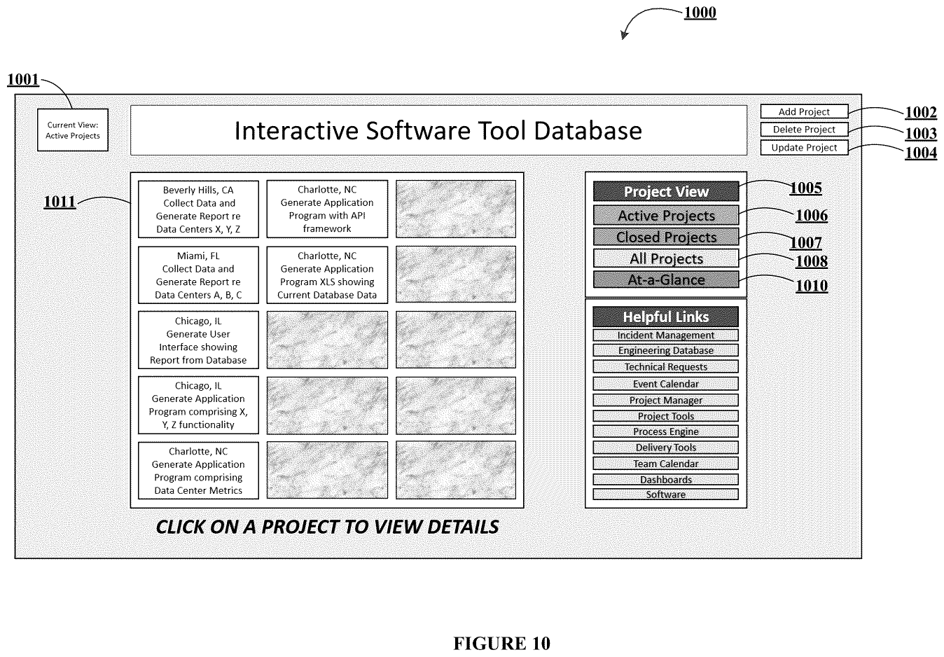

Additionally, and in some embodiments, the interactive software tool database may be interactive so the user can select or click on the components within the configured GUI to show more details or data on each software tool. Such details may comprise the current status of each software tool (e.g., active or inactive), the last time the software tool was used, the recipient identifiers of each software tool, the user identifier that requested the software tool be generated, the security requirement for the software tool, what the software tool does, and/or the like. An example interactive software tool database is shown and described below with respect to FIG. 10.

FIG. 4 illustrates a process flow 400 for determining a security clearance of a user account for the generation of the software tool, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process flow 400. Additionally, and in some embodiments, a generative AI engine (e.g., the generative AI subsystem 200 described herein with respect to FIG. 2) may be generated to perform the steps of process flow 400.

In some embodiments, and as shown in block 402, the process flow 400 may include the step of identifying a user account associated with the user device, wherein the user interacting with the user device causes a generation of the software tool request and the at least one data source identifier. For instance, and in some such embodiments, the system may identify a user account associated with the user device that generated and submitted the software tool request in block 302, and/or submitted response user inputs to each of the interactive generative AI engine prompts. In some embodiments, the user account may be identified by the user of the user device submitting authentication credentials to the system comprising the interactive generative AI engine, whereby the system may identify the user account based on the received authentication credentials (e.g., username, password, and/or the like). In some embodiments, and upon a user logging into a network connected to the user device, logging into the user device, and/or logging into applications or a desktop virtually, the system may collect the authentication credentials used at any of these logins to determine the user account.

In some embodiments, and as shown in block 404, the process flow 400 may include the step of determining a security clearance of the user account. For instance, the system may determine a security clearance associated with the user account by parsing the data of the user account and identifying a security clearance for the overall user account (which may be used as a one-time password to access a plurality of applications, programs, databases, data sources, and/or the like that meets an associated security requirement), and/or identifying individual security clearances for a plurality of applications, programs, databases, data sources and/or the like. Thus, and in other words, the user account may comprise one security clearance which may be compared against all the security requirements for each program, application, database, data source, and/or the like, or the user account may comprise a plurality of security clearances that are each associated with a specific program, application, database, data source, and/or the like.

In some embodiments, the system may determine the security clearance(s) of the user account based on parsing the attributes and/or data of the user account, and identifying the security clearance(s) the user is allowed. In some embodiments, the security clearance data may be stored as metadata within the user account data. In some embodiments, the security clearance may be stored separately from the user account (in order to prevent hacking or changing of the security clearance by hacking the user account), and the system may access an encrypted security clearance database to access each security clearance for each user account within a network. Thus, and in some such embodiments, the security clearance database may organize and store each security clearance with its linked user account, such that the system may search or query the user account identifier to determine the linked security clearance(s).

In some embodiments, and as shown in block 406, the process flow 400 may include the step of comparing the security clearance with a security requirement associated with the at least one data source. For instance, the system may compare the security clearance (e.g., a security clearance may comprise a numerical level indicator such as 1, 2, 3, 4, and/or the like, an alphabetical letter such as A, B, C, D, and/or the like) with a security requirement for the identified data source from FIG. 3 (which the user may have generated and submitted to the system). In some such embodiments, the format of the security clearance (e.g., numerical level, alphabetical letter, and/or the like) may be the same format for the security requirement, thus allowing for a like-to-like comparison. In some embodiments, a security clearance of a highest level (e.g., A, 1, and/or the like) may indicate the user of the user account has the highest security clearance, and thus, can access all the data sources in the network associated with the system. Similarly, a security clearance of the lowest level (e.g., D, 4, and/or the like) may indicate that the user of the user account can only access a limited number of data sources within the network (those with the lowest security requirement).

In some embodiments, the system may determine the security requirement of the data source(s) based on parsing the metadata of the data source(s), and determining the requirement for a user to be able to access the data source(s). In some embodiments, the security requirements for each data source within a network may be stored in a secure and encrypted security requirement database, similar to the security clearance database described above.

In some embodiments, the system may compare the security clearance of the user account and the security requirement of each data source identified in FIG. 3, and determine whether the user account that submitted the software tool request and the data source identifier can access the data within the data source, and thus, can access the software tool that will be generated with the data from the data source. In this manner, the system may proactively determine (before generating the software tool with the data source identifier data) whether the software tool should be generated at all or should be generated with a lower security requirement data source identifier. For instance, and where the security requirement of a data source associated with the data source identifier is a level of B, and the security clearance of the user account is only C (e.g., the security clearance is less than the security requirement), the system may block the generation of the software tool completely, and/or block the use of the data source identifier data to generate the software tool.

In some embodiments, and as shown in block 408, the process flow 400 may include the step of automatically allowing the generating of the software tool in an instance where the security clearance meets or exceeds the security requirement. For instance, and in some embodiments, the system may automatically allow the generation of the software tool using the data of the data source identifier(s) that had a security requirement that met or was less than the security clearance of the user account. In some embodiments, and where multiple data source identifiers were submitted to the system, and all but one of the data source identifiers comprised a security requirement equal to or less than the user account security clearance (i.e., one data source identifier comprised a security requirement that exceeded the security clearance of the user), the system may automatically block the generation of the software tool (or require a different data source identifier to be received or identified that meets or is less than the security clearance and comprises similar data or similar code portions/application pieces). Further, an in response to the comparison, the system may allow the access of the user to the software tool upon generation, in an instance where the user account comprises a security clearance that meets or exceeds the data source identifier security requirement(s).

In some embodiments, and as shown in block 410, the process flow 400 may include the step of automatically blocking the generation of the software tool in an instance where the security clearance does not meet or exceed the security requirement. For example, and in some embodiments, the system may automatically block the generation of the software tool in an instance where at least one of the data source identifiers comprises a security requirement that exceeds the security clearance of the user account. In some of alternative embodiments, and where at least one of the data source identifiers comprises a security requirement that exceeds the security clearance of the user account, the interactive generative AI engine may itself determine similar data source identifiers that can be used in the place of the data source identifier that the user is unable to access, whereby the interactive generative AI engine may know the data stored in each of the data sources. In some embodiments, the interactive generative AI engine may access the data within the data sources to determine which data sources are similar within a sandbox environment or within a firewall environment, such that the user interacting with the interactive generative AI engine cannot see the underlying data within each data source being analyzed (which may include the data source the user is unable to access based on their security clearance).

FIG. 5 illustrates a process flow 500 for determining a recipient security clearance of a recipient user account for receiving the software tool, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process flow 500. Additionally, and in some embodiments, a generative AI engine (e.g., the generative AI subsystem 200 described herein with respect to FIG. 2) may be generated to perform the steps of process flow 500.

In some embodiments, and as shown in block 502, the process flow 500 may include the step of receiving, by the interactive generative AI engine, at least one recipient identifier to receive the software tool. For instance, the interactive generative AI engine may receive at least one recipient identifier at the user device which is intended to receive the software tool that was generated in FIG. 3 or intended to receive an output from the software tool generated in FIG. 3. Thus, and in some such embodiments, the user of the user device may generate a user input at the interactive generative AI engine comprising one or more recipient identifiers that the user would like for the system to automatically transmit the software tool or software tool outputs upon generation. Such a recipient identifier may comprise a recipient username, email address, office address, facsimile number, and/or the like. An example embodiment where the system may receive the recipient identifier(s) is shown and described in further detail below with respect to FIG. 9.

In some embodiments, and as shown in block 504, the process flow 500 may include the step of identifying, based on the at least one recipient identifier, at least one recipient security clearance for each of the at least one recipient identifier. For instance, the system may identify the recipient security clearances for each recipient identifier received in block 502. Such an identification of the recipient security clearances may occur in the same or similar manner as that described above with respect to identifying security clearances for the user account in FIG. 4. Thus, and in some embodiments, the recipient security clearance may likewise comprise numerical levels, alphabetical letters, and/or the like, and may comprise a plurality of recipient security clearances (a plurality of recipient security clearances for each program, application, database, data sources, and/or the like) or a singular recipient security clearance for the network.

In some embodiments, and as shown in block 506, the process flow 500 may include the step of comparing the at least one recipient security clearance with a security requirement associated with the at least one data source identifier. For instance, and similarly to the identification of the security requirement for the data source in FIG. 4, the same identification process may occur here to determine the security requirement for the data sources identified and used to generate the software tool. Additionality, and similar to FIG. 4, the system may likewise compare the recipient security clearances with the security requirements of the data sources and determine if the recipients identified by the user are able to access the underlying data form the data sources, and thus, should be able to access the software tool using the data source data.

Thus, and in some such embodiments, the system may compare the security requirement with the recipient security clearance in a similar manner that described above with respect to comparing the security clearance of the user account with the security requirement of the data source identifier. In an instance where a plurality of recipient identifiers are received and one recipient identifier within the plurality of recipient identifiers is determined to not be able to access the underlying data from the data source(s) used to generate the software tool, then the interactive generative AI engine may generate an updated recipient identifier prompt asking for an additional recipient identifier to take the place of the invalidated recipient identifier or may generate an alert indicating that the recipient identifier will not receive the software tool or its output.

In some embodiments, and as shown in block 508, the process flow 500 may include the step of automatically allowing the transmission of the software tool to at least one recipient account associated with each of the at least one recipient identifier that comprises the at least one recipient security clearance that meets or exceeds the security requirement. Thus, and in some such embodiments, the system may automatically allow the transmission of the software tool (and/or its output) to the recipients associated with the validated recipient identifiers. In some embodiments, and where the user indicates that the software tool (and/or its output) should be transmitted continuously and a pre-determined intervals (e.g., weekly, monthly, and/or the like), the system may perform the same analysis as that described hereinabove with respect to FIGS. 4 and 5 to revalidate or invalidate each user and/or each recipient identifier each time before the software tool (or its output) is retransmitted.

Thus, and in some embodiments, the system may automatically transmit the software tool (and/or its output) to the recipient account, recipient device, recipient email, and/or the like, associated with the recipient identifier that was determined to have the recipient security clearance that meets or exceeds the security requirement for the data source used to generate the software tool.

In some embodiments, and as shown in block 510, the process flow 500 may include the step of generating, by the interactive generative AI engine and in an instance where the at least one recipient security clearance does not exceed the security requirement, an updated recipient identifier prompt. For example, and in some such embodiments, the system may generate an updated recipient identifier prompt that requests the user that initially submitted the recipient identifier to receive the software tool (and/or its output) to generate and submit a new recipient identifier for the same user (e.g. another account with a higher security clearance, fix an issue with the initial recipient identifier such as correct an incorrect email address), a request the user identify another recipient identifier for a different user, and/or a request that the user indicates that no other recipient users should receive the software tool (or its output).

In some embodiments, and as shown in block 512, the process flow 500 may include the step of transmitting the updated recipient identifier prompt to the user device. Thus, and in some such embodiments, the updated recipient identifier prompt may be transmitted to the user device and used to configure the GUI of the user device and ask for an updated recipient identifier or ask to correct the previously received recipient identifier.

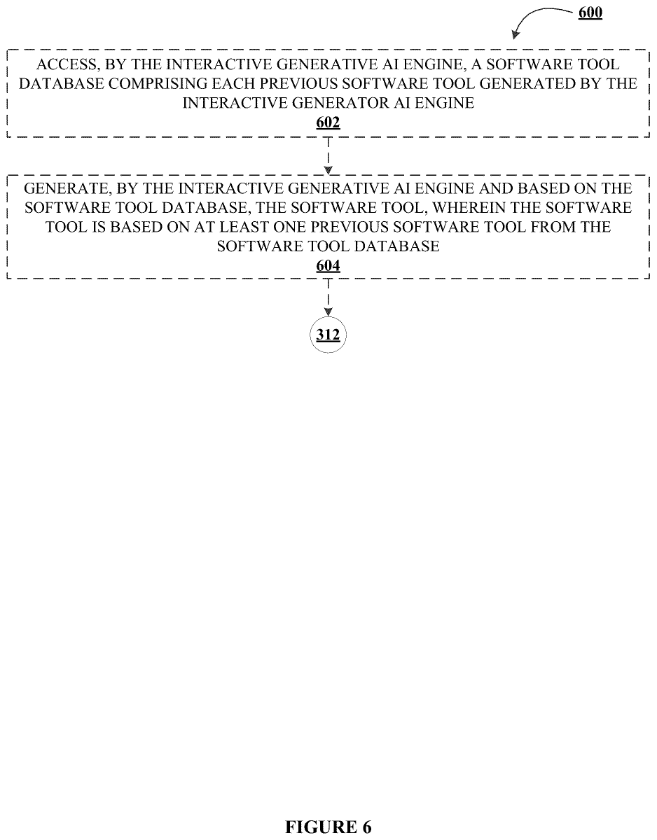

FIG. 6 illustrates a process flow 600 for generating the software tool using previously generated software tools, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process flow 600. Additionally, and in some embodiments, a generative AI engine (e.g., the generative AI subsystem 200 described herein with respect to FIG. 2) may be generated to perform the steps of process flow 600.

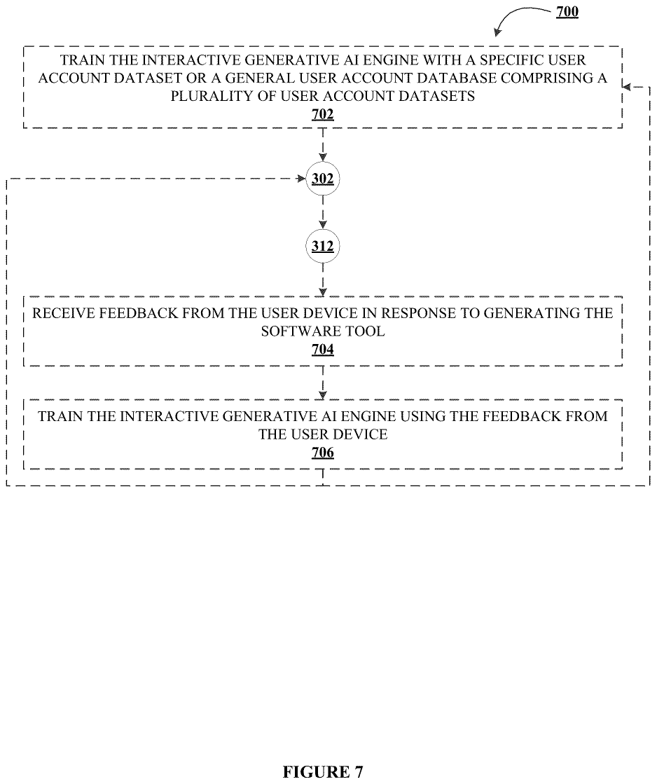

In some embodiments, and as shown in block 602, the process flow 600 may include the step of accessing, by the interactive generative AI engine, a software tool database comprising each previous software tool generated by the interactive generator AI engine. For instance, and in some such embodiments, the interactive generative AI engine may access a software tool database comprising each of the software tools that have previously been generated within the network associated with the network associated with the system (e.g., those software tools that were manually generated or automatically generated by the interactive generative AI engine). In this manner, the interactive generative AI engine may be pre-trained on the software tool database, its historical software tools and associated data (e.g., purpose behind generating the software tool, data sources used to generate the software tools, and/or the like). In some embodiments, and as described in further detail below with respect to FIG. 7, the interactive generative AI engine may further be trained on a continuous basis with the current software tools generated for a single users or a plurality of users, and any feedback received after the software tool is generated and/or used.

In some embodiments, and as shown in block 604, the process flow 600 may include the step of generating by the interactive generative AI engine and based on the software tool database, the software tool, wherein the software tool is based on at least one previous software tool from the software tool database. For instance, and in some embodiments, the system may generate and train the interactive generative AI engine using the software tool database at least on an initial basis (and some embodiments on an iterative basis as the software tool database is updated and new software tools are generated and used). Thus, and based on this training of the interactive generative AI engine, the interactive generative AI engine may generate each current software tool based on determining the closest historical software tools and tweaking or slightly changing the historical software tools to arrive at the request software tool. In such an embodiment, the interactive generative AI engine may streamline its generation of new software tools by accessing and using similar historical software tools when generating new software tools. Thus, and in some embodiments, the process described herein with respect to FIG. 6 may precede the process described in block 212, such that the software tool is generated based on previously generated software tools and the process of generating the software tool is streamlined.

FIG. 7 illustrates a process flow 700 for training the interactive generative AI engine in multiple instances, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process flow 700. Additionally, and in some embodiments, a generative AI engine (e.g., the generative AI subsystem 200 described herein with respect to FIG. 2) may be generated to perform the steps of process flow 700.

In some embodiments, and as shown in block 702, the process flow 700 may include the step of training the interactive generative AI engine with a specific user account dataset or a general user account database comprising a plurality of user account datasets. For instance, and in some embodiments, the system may train the interactive generative AI engine with a specific user account dataset (e.g., a dataset of historical software tools, historical software tool requests, recipient identifiers, historical data source identifiers, and/or the like), which may be used to train the interactive generative AI engine in a user-specific manner. Additionally, and/or alternatively, the interactive generative AI engine may be trained with a general user account database comprising a plurality of user account datasets, and thus, the interactive generative AI engine may be trained to handle different software tool requests for a plurality of different users. In either instance, and based on the user account datasets used to train the interactive generative AI engine, the interactive generative AI engine may be finitely trained to more accurately interact with those users associated with the user account datasets and generate the requested software tool without errors or with minimal errors.

In some embodiments, and as shown in FIG. 7, the process described herein for block 702 may precede the generation of the interactive generative AI engine (e.g., the interactive generative AI engine may be trained before it can be used to generate a software tool in FIG. 3).

In some embodiments, and as shown in block 704, the process flow 700 may include the step of receiving feedback from the user device in response to generating the software tool. For instance, and in some such embodiments, the system may receive feedback from the user device and/or from recipient user devices that received the software tool (and/or its output), indicating whether the software tool (or its output) was satisfactory or needs to be updated/regenerated. In some embodiments, and based on this feedback, the interactive generative AI engine may be retrained in real time or near real time to receive the feedback and/or updating the interactive generative AI engine.

In some embodiments, and as shown in block 706, the process flow 700 may include the step of training the interactive generative AI engine using the feedback from the user device. Thus, and as described above, the system may train the interactive generative AI engine using the feedback from the user device (and/or the recipient user device(s)). Further, and as shown in FIG. 7, the process described herein for training the interactive generative AI engine at block 706 may precede the process described with respect to block 702. Similarly, and in some embodiments, the process described herein for training the interactive generative AI engine at block 706 may precede the process described with respect to block 302 in generating the process described herein for training the interactive generative AI engine at block 706 may precede the process described with respect to block 702.

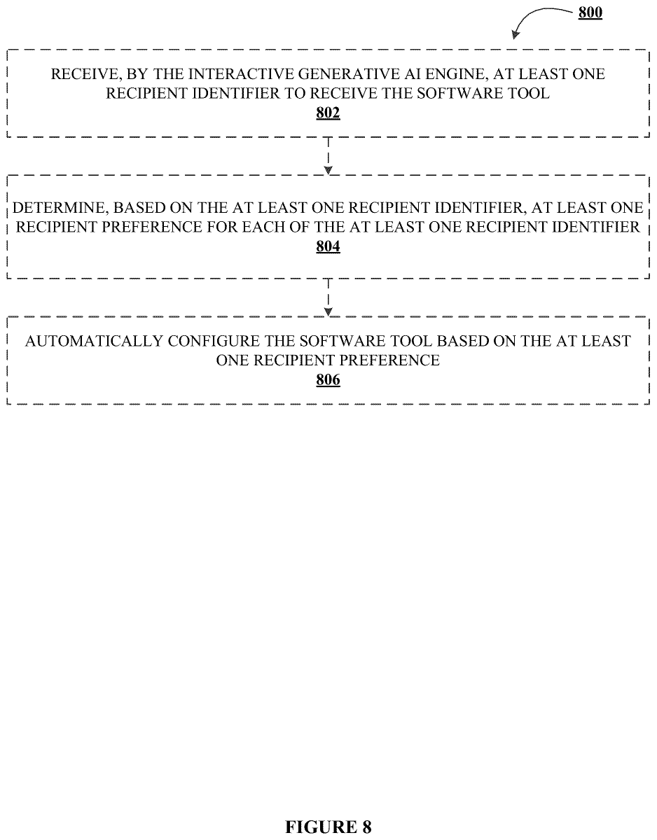

FIG. 8 illustrates a process flow 800 for automatically configuring the software tool based on the recipient preference(s), in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIG. 1A-1C) may perform the steps of process flow 800. Additionally, and in some embodiments, a generative AI engine (e.g., the generative AI subsystem 200 described herein with respect to FIG. 2) may be generated to perform the steps of process flow 800.

In some embodiments, and as shown in block 802, the process flow 800 may include the step of receiving, by the interactive generative AI engine, at least one recipient identifier to receive the software tool. For instance, the interactive generative AI engine may receive at least one recipient identifier to receive the software tool in the same or similar manner to the process for receiving the recipient identifier(s) as that described above.

In some embodiments, and as shown in block 804, the process flow 800 may include the step of determining, based on the at least one recipient identifier, at least one recipient preference for each of the at least one recipient identifier. For instance, and in such embodiments, the system may determine—using the recipient identifiers—the recipient preferences for each recipient account associated with identified recipient identifier. For instance, such recipient preferences may comprise preferences for file types to receive the software tool and/or its output, formatting preferences, GUI formatting and organization preferences (whether certain software tools and its output should be shown in real time to receiving them and based on a higher importance), and/or the like.

In some such embodiments, the recipient preferences may be determined based on historical recipient preferences for the specific recipient, based on metadata stored in the recipient user account, within metadata stored within a preference database and linked to the recipient identifier, and/or the like. In some embodiments, the system may access a preference database in a same or similar manner as that described above for accessing the other databases described herein (e.g., security clearance database, and/or the like).

In some embodiments, and as shown in block 806, the process flow 800 may include the step of automatically configuring the software tool based on the at least one recipient preference. For instance, and in some embodiments, the system may automatically configure the software tool (and/or its output) specifically to each recipient identifier and each recipient preference. Thus, and in some such embodiments, the system may configure the same software tool (and/or its output) a number of different ways, where each configuration may be specific to the recipient receiving the software tool (and/or its output).

FIG. 9 illustrates an exemplary interactive generative AI engine configured on a graphical user interface 900, in accordance with an embodiment of the disclosure. In some embodiments, a system (e.g., similar to one or more of the systems described herein with respect to FIGS. 1A-1C) may perform one or more of the steps for generating and using the exemplary interactive generative AI engine on a GUI 900. For example, a system (e.g., the system 130 described herein with respect to FIG. 1A-1C) may perform the steps for generating and using the exemplary interactive generative AI engine on a GUI 900. Additionally, and in some embodiments, a generative AI engine (e.g., the generative AI subsystem 200 described herein with respect to FIG. 2) may be generated to perform the steps for generating and using the exemplary interactive generative AI engine on a GUI 900.

Thus, and as shown in the exemplary interactive generative AI engine configured on the GUI 900, the interactive generative AI engine may first generate an initial prompt comprising a user input type prompt 901 (e.g., would the user like to type and/or speak their user inputs), which the user device may be used to generate and transmit a user input type response 902. Additionally, and as shown in GUI 900, the interactive generative AI engine may generate a software tool prompt 903, which the user device may be used to generate a software tool request 904 (e.g., “create a new report”). As shown in GUI 900, the interactive generative AI engine may generate a data source prompt 905 (e.g., “where can I find the data?”), which the user device may be used to generate at least one data source identifier 906 (e.g., an https address). In some embodiments, the interactive generative AI engine may further generate a follow up or updated data source prompt 907 to request a specific data source file and/or the like. In some embodiments, the user device may receive an updated data source identifier 908 (e.g., a specific file). Further, and in some embodiments, the interactive generative AI engine may generate another follow up data source prompt 909 requesting specific pieces of data from the identified data source(s), which the user device may transmit the response to this prompt as another updated data source identifier and/or description 910.

Additionally, and in as shown in GUI 900, the interactive generative AI engine may generate a preference prompt 911 for the user, whereby the preference prompt may comprise a request of the kind of preference the user would like to receive the software tool. In some such embodiments, the interactive generative AI engine may receive a preference response 912 indicating a preference of the format, file type, and/or the like, the software tool should be generated. In some embodiments, the interactive generative AI engine may generate a preference file name prompt or software tool name prompt 913, and the user device may transmit a preference software tool name response 914 in response to the software tool name prompt 913.

Additionally, and in some embodiments, the interactive generative AI engine may generate a recipient identifier prompt 915 (which is intended to receive the software tool once generated), and the user device may transmit a recipient identifier(s) 916 to the interactive generative AI engine. In some embodiments, the interactive generative AI engine may perform an analysis on the recipient identifier(s) and determine their validity (which is similar to the process described with respect to FIG. 5) (e.g., whether the recipient of the recipient identifier has the security clearance to access the data source(s) used to generate the software tool). In some embodiments, the interactive generative AI engine may validate the recipient identifiers and determine if the recipient identifiers are incorrect or unable to access the data of the data sources (e.g., where the recipient identifier listed comprises an email address outside of the network, the recipient identifier likely won't be able to access any data within the network as the recipient will not have security clearance within the network). Thus, and as shown in GUI 900, the interactive generative AI engine may generate an updated recipient identifier prompt 917, and the user device may transmit the updated recipient identifier 918 in response to prompt 917.

In some embodiments, and as shown in GUI 900, the interactive generative AI engine may generate an interval preference prompt 919, which may request an indication of whether the user (and/or their recipient identifiers) would like to receive the software tool at pre-defined intervals and on a continuous basis. In such an embodiment, the user device may transmit an interval preference response 920 back to the interactive generative AI engine. Lastly, and in some embodiments, the interactive generative AI engine may generate a final prompt indicating the software tool has been generated and is viewable in the interactive software tool database 921.

In some embodiments, the interactive generative AI engine may comprise an interactive component within the configured GUI 923 (e.g., which may receive the user input as a typed user input). In some further embodiments, the interactive generative AI engine may further comprise a send or transmit interactive component within the configured GUI 924, which may be used by the user interacting with the user device to transmit their user input to the interactive generative AI engine.

FIG. 10 illustrates an exemplary interactive software tool database 1000, in accordance with an embodiment of the disclosure. In some embodiments, a system (e.g., similar to one or more of the systems described herein with respect to FIGS. 1A-1C) may perform one or more of the steps for generating an interactive software tool database 1000. For example, a system (e.g., the system 130 described herein with respect to FIG. 1A-1C) may perform the steps for generating an interactive software tool database 1000. Additionally, and in some embodiments, a generative AI engine (e.g., the generative AI subsystem 200 described herein with respect to FIG. 2) may be generated to perform the steps for generating an interactive software tool database 1000.

As shown in exemplary interactive software tool database 1000, the interactive generative AI engine may be used by the system to configure a GUI on a user device to show the historical software tools and their statuses (e.g., active, inactive/closed, all software tools, and/or the like). Thus, and as shown in the interactive software tool database 1000, the interactive software tool database 1000 may comprise an interface component 1001 indicating which view is currently shown in the interactive software tool database 1000 (e.g., active projects/active software tools that are required for active tasks or projects). Similarly, the interactive software tool database 1000 may further comprise the details of each software tool and their associated information (e.g., the project or task each software tool was generated for) 1011. The interactive software tool database 1000 may further comprise interactive interface components that a user may select or click on to add projects and/or add software tools 1002, delete projects/delete software tools 1003, and/or update projects/update software tools 1004.

Additionally, and in some embodiments, the interactive software tool database 1000 may further comprise interactive interface components that may show an updated view of the GUI with a project or task view 1005, active projects with active software tools 1006, closed projects with closed or inactive software tools 1007, all projects and all historical software tools 1008, and/or current software tools 1010.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically and dynamically generating software programs from disparate sources, the system comprising:
a memory device with computer-readable program code stored thereon;
at least one processing device operatively coupled to the at least one memory device and the at least one communication device, wherein executing the computer-readable code is configured to cause the at least one processing device to:
generate an interactive generative artificial intelligence (AI) engine, wherein the interactive generative AI engine is configured on a graphical user interface (GUI) of a user device;
receive, by the interactive generative AI engine, at least one software tool request;
generate, by the interactive generative AI engine and based on the at least one software tool request, a data source prompt;
receive, by the interactive generative AI engine, at least one data source identifier in response to the data source prompt;
access, by the interactive generative AI engine, at least one data source associated with the at least one data source identifier; and
automatically generate, by the interactive generative AI engine, a software tool based on the software tool request and the at least one data source.

2. The system of claim 1, wherein the at least one data source is a plurality of disparate data sources.

3. The system of claim 1, wherein executing the computer-readable code is further configured to cause the at least one processing device to:
identify a user account associated with the user device, wherein the user interacting with the user device causes a generation of the software tool request and the at least one data source identifier;
determine a security clearance of the user account;
compare the security clearance with a security requirement associated with the at least one data source identifier; and
automatically allow the generation of the software tool in an instance where the security clearance meets or exceeds the security requirement.

4. The system of claim 3, wherein executing the computer-readable code is further configured to cause the at least one processing device to:
automatically block the generation of the software tool in an instance where the security clearance does not meet or exceed the security requirement.

5. The system of claim 1, wherein executing the computer-readable code is further configured to cause the at least one processing device to:
receive, by the interactive generative AI engine, at least one recipient identifier to receive the software tool;
identify, based on the at least one recipient identifier, at least one recipient security clearance for each of the at least one recipient identifier;
compare the at least one recipient security clearance with a security requirement associated with the at least one data source identifier; and
automatically allow the transmission of the software tool to at least one recipient account associated with each of the at least one recipient identifier that comprises the at least one recipient security clearance that meets or exceeds the security requirement.

6. The system of claim 5, wherein executing the computer-readable code is further configured to cause the at least one processing device to:
generate, by the interactive generative AI engine and in an instance where the at least one recipient security clearance does not exceed the security requirement, an updated recipient identifier prompt; and
transmit the updated recipient identifier prompt to the user device.

7. The system of claim 1, wherein at least one of the data source prompt, a recipient identifier prompt, or an updated recipient identifier prompt is generated as a computer-generated speaker output.

8. The system of claim 1, wherein at least one of the at least one software tool request, the at least one data source identifier, or a recipient identifier is received by the user device as a sound input, and wherein the interactive generative AI engine parses and extracts the at least one software tool request, the at least one data source identifier, or the recipient identifier from the sound input.

9. The system of claim 1, wherein executing the computer-readable code is further configured to cause the at least one processing device to:
generate an interactive software tool database, wherein the interactive software tool database is configured on the GUI of the user device, and wherein the interactive software tool database comprises each software tool generated for a user account with real-time data of each software tool comprising an active software tool task indicator or an inactive software tool task indicator.

10. The system of claim 1, wherein executing the computer-readable code is further configured to cause the at least one processing device to:
access, by the interactive generative AI engine, a software tool database comprising each previous software tool generated by the interactive generative AI engine;
generate, by the interactive generative AI engine and based on the software tool database, the software tool, wherein the software tool is based on at least one previous software tool from the software tool database.

11. The system of claim 1, wherein executing the computer-readable code is further configured to cause the at least one processing device to:
train the interactive generative AI engine with a specific user account dataset or a general user account database comprising a plurality of user account datasets.

12. The system of claim 1, wherein executing the computer-readable code is further configured to cause the at least one processing device to:
receive feedback from the user device in response to generating the software tool; and
train the interactive generative AI engine using the feedback from the user device.

13. The system of claim 1, wherein executing the computer-readable code is further configured to cause the at least one processing device to:
receive, by the interactive generative AI engine, at least one recipient identifier to receive the software tool;
determine, based on the at least one recipient identifier, at least one recipient preference for each of the at least one recipient identifier; and
automatically configure the software tool based on the at least one recipient preference.

14. A computer program product for automatically and dynamically generating software programs from disparate sources, wherein the computer program product comprises at least one non-transitory computer-readable medium having computer-readable program code portions embodied therein, the computer-readable program code portions which when executed by a processing device are configured to cause the processor to:
generate an interactive generative artificial intelligence (AI) engine, wherein the interactive generative AI engine is configured on a graphical user interface (GUI) of a user device;
receive, by the interactive generative AI engine, at least one software tool request;
generate, by the interactive generative AI engine and based on the at least one software tool request, a data source prompt;
receive, by the interactive generative AI engine, at least one data source identifier in response to the data source prompt;
access, by the interactive generative AI engine, at least one data source associated with the at least one data source identifier; and
automatically generate, by the interactive generative AI engine, a software tool based on the software tool request and the at least one data source.

15. The computer program product of claim 14, wherein the computer-readable program code portions which when executed by the processing device are further configured to cause the processor to:
identify a user account associated with the user device, wherein the user interacting with the user device causes a generation of the software tool request and the at least one data source identifier;
determine a security clearance of the user account;
compare the security clearance with a security requirement associated with the at least one data source identifier; and
automatically allow the generation of the software tool in an instance where the security clearance meets or exceeds the security requirement.

16. The computer program product of claim 14, wherein the computer-readable program code portions which when executed by the processing device are further configured to cause the processor to:
receive, by the interactive generative AI engine, at least one recipient identifier to receive the software tool;
identify, based on the at least one recipient identifier, at least one recipient security clearance for each of the at least one recipient identifier;
compare the at least one recipient security clearance with a security requirement associated with the at least one data source identifier; and
automatically allow the transmission of the software tool to at least one recipient account associated with each of the at least one recipient identifier that comprises the at least one recipient security clearance that meets or exceeds the security requirement.

17. The computer program product of claim 14, wherein at least one of the at least one software tool request, the at least one data source identifier, or a recipient identifier is received by the user device as a sound input, and wherein the interactive generative AI engine parses and extracts the at least one software tool request, the at least one data source identifier, or the recipient identifier from the sound input.

18. A computer implemented method for automatically and dynamically generating software programs from disparate sources, the computer implemented method comprising:
generating an interactive generative artificial intelligence (AI) engine, wherein the interactive generative AI engine is configured on a graphical user interface (GUI) of a user device;
receiving, by the interactive generative AI engine, at least one software tool request;
generating, by the interactive generative AI engine and based on the at least one software tool request, a data source prompt;
receiving, by the interactive generative AI engine, at least one data source identifier in response to the data source prompt;
accessing, by the interactive generative AI engine, at least one data source associated with the at least one data source identifier; and
automatically generating, by the interactive generative AI engine, a software tool based on the software tool request and the at least one data source.

19. The computer implemented method of claim 18, further comprising:
identifying a user account associated with the user device, wherein the user interacting with the user device causes a generation of the software tool request and the at least one data source identifier;
determining a security clearance of the user account;
comparing the security clearance with a security requirement associated with the at least one data source identifier; and
automatically allowing the generation of the software tool in an instance where the security clearance meets or exceeds the security requirement.

20. The computer implemented method of claim 18, further comprising:
receiving, by the interactive generative AI engine, at least one recipient identifier to receive the software tool;
identifying, based on the at least one recipient identifier, at least one recipient security clearance for each of the at least one recipient identifier;
comparing the at least one recipient security clearance with a security requirement associated with the at least one data source identifier; and
automatically allowing the transmission of the software tool to at least one recipient account associated with each of the at least one recipient identifier that comprises the at least one recipient security clearance that meets or exceeds the security requirement.
